(19) United States
(12) Patent Application Publication
(10) Pub. No.: US 2007/0172679 A1
(43) Pub. Date: Jul. 26, 2007

(54) Office or cosmetics article

(75) Inventor: Fritz Luttgens, Erlangen (DE)

Correspondence Address: LERNER GREENBERG STEMER LLP, P O BOX 2480, HOLLYWOOD, FL, 33022-2480, US

(73) Assignee: KUM Limited, Trim (IE)

(21) Appl. No.: 11/698,313

(22) Filed: Jan. 25, 2007

(30) Foreign Application Priority Data
Jan. 25, 2006 (EP) 06 001 569.0

(51) Int. Cl. B32B 15/04; B32B 9/00

(52) U.S. Cl. 428/469; 428/698; 428/701

(57) ABSTRACT

An office or cosmetics article made of a magnesium material, in particular a sharpener body or a ruler, has an inorganic, chemically bonded protective layer including at least one element selected from the group containing the metals of the main groups III, IV, V and VI and the subgroups Ib, IVb, Vb, VIb, VIIb and VIIIb of the Periodic Table of the Elements, as well as oxides, ceramics, nitrides, carbides, silicides and borides thereof. The office or cosmetics article is lastingly protected against corrosion by virtue of such a protective layer.

### CROSS-REFERENCE TO RELATED APPLICATION

This application claims the priority, under 35 U.S.C. §119, of European Patent Application EP 06 001 569.0, filed Jan. 25, 2006; the prior application is herewith incorporated by reference in its entirety.

### BACKGROUND OF THE INVENTION

### Field of the Invention

The invention relates to an office or cosmetics article made of a magnesium material. In particular, the invention relates to a sharpener body, a ruler or a cosmetics container made of a magnesium material.

Office articles and cosmetics articles such as, in particular a sharpener body, a ruler or a cosmetics container made of a magnesium material, are known in principle. In this context, a magnesium material is used as the material due to its ready machineability and its low density. A magnesium material in this context is to be understood as including both a magnesium alloy and pure magnesium. In order to improve the mechanical processability, the hardness and the propensity toward oxidation of magnesium, magnesium alloys customarily include minor additions of aluminum, manganese, zinc, copper and/or nickel as alloy components.

Disadvantageously, a magnesium material has an undesirable propensity toward oxidation. In office articles made of a magnesium material, that will result, over time, in undesirable changes in color and, in particular, unattractive efflorescence. In order to prevent that occurrence, it is known, for example, to seal the surface of such office articles made of a magnesium material through the use of a lacquer. Due to the frequent use of an office article, however, rapid wear of such a lacquer based on organic substances will take place, so that even a lacquered office article will quickly become unsightly. An aluminum alloy does not represent an equivalent alternative to a magnesium alloy in mass-produced goods such as an office article, since an aluminum alloy is considerably less readily machinable. That results in unacceptable additional costs. Nor does the use of an alloy suitable for a casting process, for example of iron, instead of a magnesium material, represent a sensible alternative, since the casting molds required are expensive and, moreover, have only a limited life. Fettling or deburring and surface finishing of castings moreover require a reworking operation.

### SUMMARY OF THE INVENTION

It is accordingly an object of the invention to provide an office or cosmetics article made of a magnesium material, which overcomes the hereinafore-mentioned disadvantages of the heretofore-known devices of this general type and which has as long a service life as possible without unattractive changes to its surface.

With the foregoing and other objects in view there is provided, in accordance with the invention, an office or cosmetics article, comprising a body formed of a magnesium material, in particular a sharpener body, a ruler or a cosmetics container. An inorganic protective layer is chemically bonded to the body. The protective layer includes at least one element selected from the group containing metals of the main groups III, IV, V and VI and the subgroups Ib, IVb, Vb, VIb, VIIb and VIIIb of the Periodic Table of the Elements, and oxides, ceramics, nitrides, carbides, silicides and borides thereof.

The invention described herein is based on the concept that a lacquer for sealing the surface of an office article made from a magnesium material is not sufficiently well bound to the magnesium material. Especially in an office article that is in constant use, that will lead to rapid abrasion or chipping of the lacquer layer, especially at points subject to heavy wear, which means that the office article as a whole will become unsightly and, moreover, the magnesium material then exposed will in turn have a propensity to oxidize.

The invention is furthermore based on the insight that chemical bonding is associated with stronger binding forces, as compared with physical bonding. A lacquer layer, however, adheres to a body, in particular, by virtue of adhesion and/or form-locking at the microscopic level. A form-locking connection is one which connects two elements together due to the shape of the elements themselves, as opposed to a force-locking connection, which locks the elements together by force external to the elements. The drawbacks associated with such physical bonding are overcome by providing the office article made from a magnesium material with a protective layer made of an inorganic composition, which can be chemically bound to the magnesium material. The metals of the main groups III, IV, V and VI and the subgroups Ib, IVb, Vb, VIb, VIIb and VIIIb of the Periodic Table of the Elements, as well as oxides, ceramics, nitrides, carbides, silicides and borides thereof, are suitable for such a protective layer.

The invention provides the further advantage that the chemically bonded protective layer having the same effectiveness is significantly thinner than a known lacquer.

Consequently, less material is used overall, providing a benefit in terms of costs. Furthermore, the materials used can be readily recycled.

In the case of a metal, the protective layer is attached to the office/cosmetics article through a metallic bond. In such a configuration it is possible, in particular between the metal alloy and the metal deposited as a protective layer, for a mixed phase to occur. Suitable metal layers can be prepared, for example, by reductive electrodeposition of metal cations, metalates and/or metal complexes on the surface of the office/cosmetics article. Such metal layers can be deposited on the magnesium material independently of the electrochemical potential series, by choosing suitable reaction media such as complexants or solvents. A deposition in this process is performed, for example, by a simple immersion method.

In so doing, a metal oxide or a metal mixed oxide of the above-mentioned metals can be generated by the simultaneous addition of a suitable oxidant or by selecting suitable counter-anions on the surface of the office or cosmetics article made of the magnesium material.

The term oxides refers both to oxides of the above-mentioned metals as well as to mixed oxides including a plurality of these metals. The term ceramics is to be understood as such materials including the above-mentioned metal oxides which have a crystalline structure of at least 30% by volume. For example, an Al₂O₃ layer deposited on the magnesium material can also be referred to as a ceramic.

The terms nitrides, carbides, silicides and borides are to be understood as such chemical compositions or compounds of the above-mentioned metals which contain nitrogen, carbon, silicon and boron. Their composition need not be stoichiometric. Chemical bonding to the magnesium material is possible either directly or through the use of transitional phases.

Both the protective layer as such and any transitional phase which may be present between the protective layer and the magnesium material can be stoichiometric or nonstoichiometric composition. Chemical bonding can therefore take place by the lattice sites being occupied by foreign atoms or by them being intercalated into the volume of existing lattice structures.

Long-term corrosion protection is achieved by chemical bonding of the protective layer to the magnesium material of the office article. The magnesium is protected against oxidation.

In accordance with another feature of the invention, the protective layer includes at least one element which is selected from the group containing aluminum, tin, vanadium, chromium, molybdenum, zirconium, hafnium, titanium, iron, tungsten, platinum, copper, silver, gold and oxides, ceramics, nitrides, carbides, silicides and borides thereof. Aluminum, tin and titanium, due to their ability to form stable oxidation layers, are well suited as protective layers against corrosion of the magnesium material. In addition to their metallic coloration, vanadium and chromium have high mechanical strength. Chromium, iron, molybdenum and tungsten are well suited as a protective layer, particularly taking the form of a metal nitride or nitrided metal, since such metal nitrides have high hardness and stability. Chemical bonding to the magnesium material can be achieved, for example, through the use of an interlayer made of a metal. The deposited interlayer can then be nitrided on the surface.

Tungsten can be deposited on the magnesium material as an alloy component and, in particular, in the form of a tungsten carbide. This renders the office or cosmetics article resistant and hard, in particular.

The additionally listed nobler metals platinum, copper, silver and gold form a reliable protective layer, exhibit a beautiful color and furthermore have antibacterial characteristics.

The invention is not limited to the formation of a single layer. Rather, the protective layer can also include a combination of different layers. For example a mixed oxide layer can be combined with a nitride or boride layer in order to effect hardening.

In accordance with a further feature of the invention, the protective layer includes at least one layer made of a metal nitride, a metal carbide, a metal silicide or a metal boride. Such layers exhibit high hardness, which means that the office article is protected not only against corrosion but also against premature wear in the event of frequent use.

In accordance with an added feature of the invention, regarding the metal nitride, it is advantageous to deposit a nitrided metal layer. To this end, for example, a metal layer is first deposited onto the office or cosmetics article, especially through the use of an electro dip coating process. To this end, the article is dipped into an appropriate solution of a salt of a nobler metal, to cause the nobler metal to be deposited on the magnesium. In the process, the metal is chemically bound to the magnesium material. The metal nitride is produced subsequently by controlled introduction of nitrogen. This can be effected, for example, through the use of a nitrogen plasma. The nitrogen plasma can be generated through the use of an electrical discharge, for example through an arc. Simultaneous introduction of nitrogen and the desired metal is not recommended, since magnesium nitride is unstable. As to the metal boride, it is advantageous for this to be deposited on the magnesium material by applying a boron compound, in particular a boric acid ester. As boron oxide is formed, magnesium is oxidized. Consequently, mixed oxides are formed in the process for chemical bonding.

In accordance with an additional feature of the invention, mixed oxides can advantageously be used for the purpose of coloring the office article. The coloring is controlled through the oxidation states of the metal present in the mixed oxide. In that respect, it is advantageous for the protective layer to include at least one layer made of a metal oxide, especially of a metal mixed oxide. A layer of this type provides the option, in addition to that of corrosion protection, of a long-term coloration of the office article made from a magnesium material. Particularly suitable in this context are titanium oxides in the oxidation states controllable through mixed oxides. Alternative options in this context include the use of mixed oxides of vanadium, zirconium, hafnium, niobium or tantalum.

In accordance with yet another feature of the invention, the magnesium material has a first layer made of a metal and a second layer made of a metal oxide as a protective layer chemically bonded thereto. In such a configuration, the metal oxide layer can, for example, be a passivation layer for the underlying metal layer, while the metal effects the chemical bonding.

In accordance with yet a further feature of the invention, an aluminum, a titanium or a vanadium as a metal, and an aluminum oxide, a titanium oxide or a vanadium oxide as a metal oxide can, in particular, be deposited on the office article made from the magnesium material. A protective layer of this type allows an office article to be fabricated in the usual manner by machining a magnesium material and then to give it the appearance of a metal-oxidic, dull-bright finish. In so doing, the corrosion protection of the magnesium material is controlled by a defined setting of the thickness of the metal oxide layer. In other words, the deposited metal layer can be anodized, with a certain degree of coloring also being possible in the process.

In accordance with yet an added feature of the invention, in order for a metal layer to be deposited, the surface of the office article must, as a rule, be freed of the oxide layer formed by the magnesium material. This can be achieved, for example, by immersion of the office article in a suitable acid, for example acetic acid or nitric acid. The office or cosmetics article can then be rinsed and the metallic finish can be deposited, for example, by reductive or electrolytic deposition of metal cations. Instead of using an acid, the oxide layer can also be removed through the use of a solution of a suitable metal salt. In the case of the deposition of aluminum, an aluminum chloride solution, for example, would be a suitable option for this purpose.

In accordance with yet an additional feature of the invention, preferably, a protective layer including a first layer made of metal and a second layer made of metal oxide, however, is applied in a single process step through dipping the office or cosmetics article into a solution of a metal salt having an appropriate pH. The reason for this is that it has been found that, in a first step, a suitable acid will remove an existing oxide layer from the magnesium material. As soon as magnesium is exposed, the metal from the solution precipitates thereon. The deposited metal is then in turn oxidized, in the sense of anodization, by a suitable oxidant or by an oxidizing counter-anion. It is thus possible, in a single process step, for the office article made from a magnesium material to be provided with a long-lasting protective layer made of a metal and a metal oxide.

In accordance with a concomitant feature of the invention, in the case of aluminum, this is achieved through the use of an acetic aluminum nitrate solution. The acetic acid removes the oxide layers on the magnesium material. The nitrate oxidizes the deposited aluminum. At the same time, an acetic aluminum nitrate solution is buffered over wide ranges, requiring only a small number of process parameters to be controlled. In particular, the magnesium material can be dipped untreated. Additionally, this too can be preceded by a cleaning step. It was found, in particular, that pretreatment in nitric acid allows a more uniform surface to be achieved. Adjusting the pH of the acetic aluminum nitrate solution allows coatings of various degrees of brightness between dull and very bright to be achieved selectively.

Other features which are considered as characteristic for the invention are set forth in the appended claims.

Although the invention is illustrated and described herein as embodied in an office or cosmetics article, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, perspective view of a sharpener;

FIG. 1B is an enlarged, perspective view of a portion of a body of the sharpener of FIG. 1A made of a magnesium material with a protective layer of chromium;

FIG. 2A is a perspective view of a sharpener similar to FIG. 1; and

FIG. 2A is an enlarged, perspective view of a portion of a body of the sharpener of FIG. 2A with a protective layer made of aluminum and an aluminum oxide.

### DESCRIPTION OF THE PREFERRED EMBODIMENTS

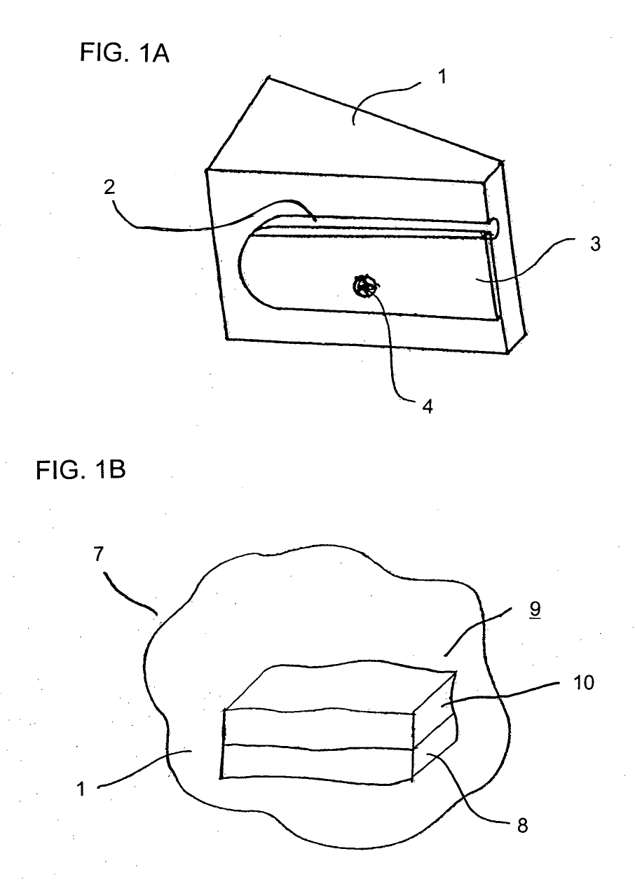

Referring now to the figures of the drawings in detail and first, particularly, to FIG. 1A thereof, there is seen a sharpener body 1 made of a magnesium alloy. The sharpener body 1 includes a conically-tapered pencil guide channel 2 having a non-illustrated opening at the left side of the figure, and a sharpener blade 3. The sharpener blade 3 is screwed onto the sharpener body 1, parallel to the conical pencil guide channel 2, through the use of a screw 4.

The sharpener body 1 was fabricated solidly by machining from a magnesium alloy containing nickel, in particular. Then the sharpener body 1 was cleaned through the use of a dipping operation in acetic acid, to remove any oxide layer present. After a rinsing operation, the cleaned sharpener body 1 was chromium-coated, by reductive deposition, by being dipped into a chromium salt solution.

An enlarged portion 7 of the body 1 shown in FIG. 1B provides a diagrammatic illustration of the surface of the sharpener body 1 which is thus coated. A surface 8 of the magnesium alloy and a protective layer 9 deposited thereon can be seen in the figure. The protective layer 9 in this case includes a metallic chromium layer 10.

The sharpener body 1 is lastingly protected against corrosion by virtue of the chromium layer 10 chemically bonded to the magnesium alloy. At the same time, the chromium layer 10 exhibits lasting metallic brightness.

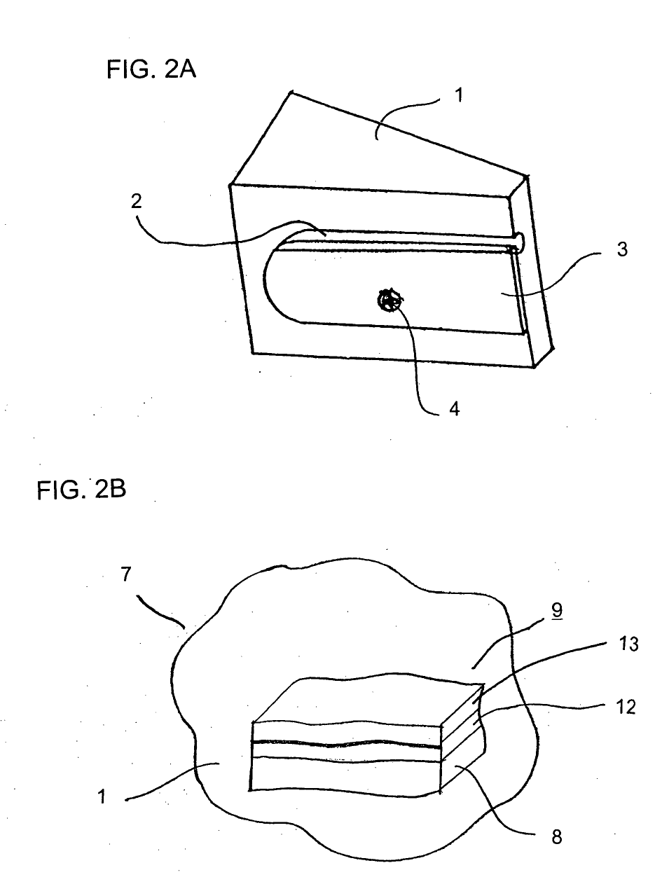

FIG. 2A again shows a sharpener body 1 with a pencil guide channel 2 and a sharpener blade 3 mounted thereon. The sharpener body 1 was solidly fabricated from a magnesium alloy through the use of machining and was then dipped in an acetic aluminum nitrate solution.

An enlarged portion 7 of the body 1 illustrated in FIG. 2B shows the type of the resulting coating. After the oxide layer present on the sharpener body 1 has been removed by the acetic acid present in the solution, an aluminum layer 12 is deposited reductively on the exposed magnesium of the magnesium alloy. The deposited aluminum layer 12 is then further anodized by the nitrate in a single operation, with the result that an aluminum oxide layer 13 is formed on the aluminum layer 12.

The protective layer 9, including the aluminum layer 12 and the aluminum oxide layer 13, provides lasting protection against corrosion of the magnesium alloy. The layer thickness can be controlled through the pH of the acetic aluminum nitrate solution and through the duration of the coating operation.

I claim:

1. An office or cosmetics article, comprising:
a body formed of a magnesium material; and
inorganic protective layer chemically bonded to said body, said protective layer including at least one element selected from the group containing metals of the main groups III, IV, V and VI and the subgroups Ib, IVb, Vb, VIb, VIIb and VIIIb of the Periodic Table of the Elements, and oxides, ceramics, nitrides, carbides, silicides and borides thereof.

2. The office or cosmetics article according to claim 1, wherein said body is a sharpener body, a ruler or a cosmetics container.

3. The office or cosmetics article according to claim 1, wherein said protective layer includes at least one element selected from the group containing Al, Sn, V, Cr, Mo, Zr, Hf, Ti, Fe, W, Pt, Cu, Ag, Au and oxides, ceramics, nitrides, carbides, silicides and borides thereof.

4. The office or cosmetics article according to claim 1, wherein said protective layer includes at least one layer made of a metal.

5. The office or cosmetics article according to claim 1, wherein said protective layer includes at least one layer made of a metal nitride, a metal carbide, a metal silicide or a metal boride.

6. The office or cosmetics article according to claim 5, wherein said metal nitride layer is a nitrided metal layer applied to said body.

7. The office or cosmetics article according to claim 6, wherein said nitrided metal layer is at least one layer selected from the group consisting of a nitrided chromium layer, a nitrided iron layer, a nitrided molybdenum layer and a nitrided tungsten layer.

8. The office or cosmetics article according to claim 5, wherein said metal boride layer is a boron compound deposited on said magnesium material body.

9. The office or cosmetics article according to claim 1, wherein said protective layer includes at least one layer made of a metal oxide.

10. The office or cosmetics article according to claim 9, wherein said metal oxide is a mixed metal oxide.

11. The office or cosmetics article according to claim 9, wherein said metal oxide includes a colored mixed oxide.

12. The office or cosmetics article according to claim 11, wherein said colored mixed oxide is at least one oxide selected from the group consisting of titanium oxide, vanadium oxide, zirconium oxide, niobium oxide and tantalum oxide.

13. The office or cosmetics article according to claim 1, wherein said protective layer contains a combination of layers having differing chemical compositions.

14. The office or cosmetics article according to claim 13, wherein said combination of layers is a metal as a first layer and a metal oxide as a second layer, chemically bonded to said magnesium material body.

15. The office or cosmetics article according to claim 14, wherein said metal is selected from the group consisting of aluminum, titanium and vanadium, and said metal oxide is selected from the group consisting of an aluminum oxide, a titanium oxide and a vanadium oxide.

16. The office or cosmetics article according to claim 15, wherein said metal and said metal oxide are jointly deposited by immersion into a solution of a corresponding metal salt having a suitable pH.

17. The office or cosmetics article according to claim 16, wherein said aluminum and said aluminum oxide have been jointly deposited on said magnesium material body by immersion into an aluminum nitrate solution in acetic acid.
